(19) United States
(12) Patent Application Publication
(10) Pub. No.: US 2020/0219187 A1
(43) Pub. Date: Jul. 9, 2020

(54) SYSTEM AND METHOD FOR ELECTRONIC PAYMENT PROCESSING AND RISK ANALYSIS

(71) Applicant: Joust Labs, Inc., Denver, CO (US)

(72) Inventor: Lamine B. Zarrad, Austin, TX (US)

(21) Appl. No.: 16/737,609

(22) Filed: Jan. 8, 2020

Related U.S. Application Data
(60) Provisional application No. 62/789,616, filed on Jan. 8, 2019.

(51) Int. Cl. G06Q 40/02; G06Q 30/04

(52) U.S. Cl. CPC G06Q 40/025; G06Q 30/04

(57) ABSTRACT

The present invention includes an inclusive electronic user transactional platform that provides access to banking, payments, and invoice features to help freelancers, independent contractors and other small businesses streamline the financial aspects of running a small or independent business. The centralized platform allows users to open a depository bank account or connect an existing bank account that is then connected to a merchant account, allowing the user to send or receive payments via credit card or ACH. The third feature is an invoice assurance tool that allows users to send invoices to their customers and chose to either factor the invoice for a fee or access an instant line of credit backed by the invoice. The platform also offers incorporation services and integrations with other business tools such as bill pay, time tracking, taxes, expenses, and others.

### CROSS-REFERENCE TO RELATED APPLICATION

The present application claims priority to U.S. provisional application Ser. No. 62/789,616 filed Jan. 8, 2019, herein incorporated by reference in its entirety.

### BACKGROUND OF THE INVENTION

The present invention generally relates to online financial services systems. More particularly, present invention relates to a banking and payment processing system configured for extending services to non-traditional customers with an application for enhanced risk management analysis.

Due to perceived risk factors, very few banks are willing to work with individuals having very little traditional established credit or who demonstrate fluctuating and non-recurring income patterns. As a result, these individuals are often denied services or charged higher fees for basic services offered by chartered financial institutions. These basic services include access to comprehensive business banking services, such as business bank accounts, lending, merchant services, and business credit. These individuals may include contractors and freelancers of the “gig” economy who have yet to establish consistent income and revenue streams or have non-traditional and non-recurring income.

Banks understand that lack of verifiable income and insufficient personal identification are important risk factors. Risk factors also arise from regulatory uncertainty. Regulatory uncertainty exists where constitutional issues, personal liberties, state rights, federal jurisdiction and treaties may be in conflict. These give rise to various unresolved legal questions involving tax, banking, and limits on sovereign exercise of authority.

Restrictions on transacting business within standard banking and financial systems may have undesirable consequences. One is that a micro-business or independent entrepreneur is hindered in growth because such individuals do not enjoy unfettered access to efficient financial services.

Regulators are hindered by the difficulty of tracking risk indicators normally monitored to address money laundering and tax collection.

What is desired is an effective solution that enables marginalized persons to engage the banking and financial systems on the same basis as others. What is also desired is a way for banks to easily satisfy their regulatory burdens while dealing with high-risk customers. What is further desired is a way to provide a convenient user experience that facilitates business and trade. What is further desired is a way to address and mitigate the risk presented by marginalized persons that is based on credible data and assures regulatory compliance.

The present invention addresses these issues by providing an inclusive platform designed to mitigate risks of transacting business with non-traditional businesses or individuals.

### SUMMARY OF THE INVENTION

Described herein are embodiments of systems and methods for enabling an inclusive electronic transactional platform having enhanced risk analysis. These systems may be implemented using a variety of hardware and may interact with transaction administrators, users, their vendors, their customers and other applicable and/or necessary parties to improve their processes, capture available information and revenue and otherwise overcome the limitations, shortcomings and disadvantages of known systems and methods. Software operates as a set of instructions running in executable memory of a processor residing on a computing device. It is to be recognized by one of skill in the art that the terms “software,” “app,” “module,” “routine,” or “sub-routine” may be used interchangeably in this specification to describe software or one or more component parts thereof. In some embodiments of the present invention, each described module or routine/sub-routine is a component part of a larger set of software instructions while in other embodiments each described module or routine/sub-routine act as independent software applications. It is to be recognized by one of skill in the art that the categorization of “modules” is merely for explanation and organizational purposes. It is also to be recognized by one of skill in the art that the terms “database” or “datastore” as used may describe a single specific database, or a sub-section of a larger database.

The present invention includes an inclusive electronic user transactional platform that provides access to banking, payments, and invoice features to help freelancers, independent contractors and other small businesses streamline the financial aspects of running a small or independent business. The centralized platform allows users to open a depository bank account or connect an existing bank account that is then connected to a user account, allowing the user to send or receive payments via credit card or ACH. Additional features include an invoice assurance tool that allows users to send invoices to their customers and chose to either factor the invoice for a fee or access an instant line of credit backed by the invoice. The platform also offers incorporation services and integrations with other business tools such as time tracking, taxes, expenses, and others.

In a first embodiment the system comprises a computer or a backend cloud server and networked devices configured with a graphical user interface (GUI) and plurality of communicatively coupled software modules configured to register users and collect and store pertinent registration data, process financial transactions, and assess the risk of providing financial services. Networked devices may include but are not limited to cell phones, handheld devices, portable tablets, portable computers, or additional computers. It is to be recognized by one of skill in the art that the GUI may be accessible through any networked device through the internet such as a world wide web portal or locally through installed software or an app. In a broader sense, the computer or backend cloud server and networked device comprise non-transitory computer-readable storage mediums having computer-executable program instructions such as the GUI and communicatively coupled software modules, stored thereon that when executed by a processor, cause the at least one computing device to operate within the guidelines of the GUI and software modules.

In one aspect of the system, the GUI includes an administrator portal (AP) and a user portal (UP). The administrator portal is a subroutine configured to allow the system administrator to oversee and control system users, provide risk analysis of system users and transactions, and facilitate financial transactions or benefits to and between users. The user portal is a subroutine configured to provide a user access to their own financial transactional data and actions, payment processing, invoicing, and additional financial services, including but not limited to bill pay, trade financing products and insurance policies.

In another aspect of system, the system includes a Registration Module (RM) that is available on or accessible through a computer or networked device. The RM is a data collection module configured to collect information regarding a user or their perspective clients. The RM may collect data including but not limited to current and former home/business addresses and phone numbers, social security/EIN numbers, date of birth, email addresses, social media accounts, current banking accounts, current lenders, or current active client or user transactions and store the data in an RM database. The RM database may be used by the administrator portal to manage all system global transactions among users, the user portal to add or revise current personal data or to view customer data, and the customer portal to add or revise current personal data.

In yet another aspect of system, the system includes a weighted risk module (WRM) that is available on or accessible through a computer or networked device. The WRM is accessible through the AP and in some aspects acts as a data collection module and in other aspects acts as a data analysis module. The WRM is configured to identify key risk factor categories, assign weighted percentages of importance in determining risk, and defines metes and bounds to particular risk factors or overall average risk for particular financial products.

The WRM is additionally configured pull data from the RM database, categorize the data into key risk factor categories, and assign a weighted score to each user and customer in order to present an overall risk factor as relates to the particular financial product. The analysis data may be stored in the WRM database. A risk data collection subroutine of the WRM may be configured to input the RM data and further collect any additional data based on the RM data.

Additional data may include but is not limited to user or customer financial account data from a plurality of credit databases and background check databases. The WRM is fully customizable so that an analyst or administrative user may create risk profiles, create risk factor categories, and assign weights according to the risk management needs of the user.

In an additional aspect of the system, the WRM compounds its risk analysis by combining data collected received from both the user and the user's customer. In this embodiment, the risk profile of the user is determined not only by the user's own actions, background, and credit, but also by the actions, background, and credit history of the user's customers.

In another embodiment of the system, the weighted risk factor may be used to determine financial terms for potential loans or lines of credit.

In yet another embodiment of the system, the weighted risk factor may be used to set terms in offering an invoice insurance financial product.

Another aspect of the system includes a method of risk analysis and the use of structured analytic techniques for evaluating the offering of financial products.

Another aspect of the system is visualization of risk using network diagraming. The WRM subroutine is configured to analyze the user risk data and the downstream user risk data and create visual risk maps and diagrams. These diagrams present a snapshot of relationships between users, transactions, locations, dates, and amounts that are customizable and give an administrative user additional insight for use in analysis.

The terms “customer”, “secondary customer,” or “user's clients” refers to customers of “users” who are using the system as merchants or vendors.

### BRIEF DESCRIPTION OF THE DRAWINGS

In the accompanying figures, like elements are identified by like reference numerals among the several preferred embodiments of the present invention.

FIG. 1 is a flow chart detailing a hardware embodiment of the system.

FIG. 2 is a flow chart detailing and embodiment of the software modules of the system.

FIGS. 3A-3B represent example GUI representations of the registration module.

FIGS. 4A-4B represent an example GUI representations of the customer/user portal module.

FIG. 5 represents an example GUI representation of the administrator portal.

FIGS. 6A-6B represent embodiments of the process flow of the weighted risk module.

FIG. 7 represents an example GUI representation of the weighted risk module.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known customary practice within the art to which the invention pertains.

### DETAILED DESCRIPTION OF THE PREFERRED EMBODIMENTS

The foregoing and other features and advantages of the invention will become more apparent from the following detailed description of exemplary embodiments, read in conjunction with the accompanying drawings. The detailed description and drawings are merely illustrative of the invention rather than limiting, the scope of the invention being defined by the appended claims and equivalents thereof.

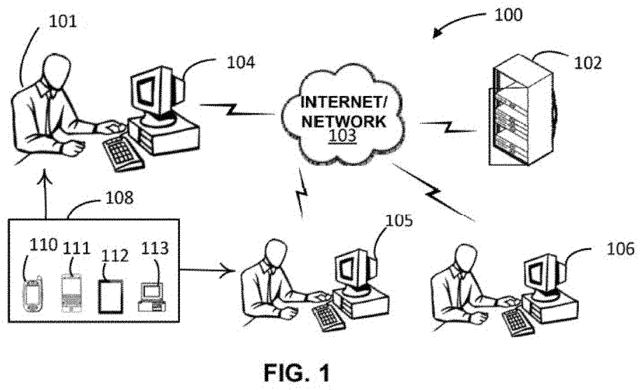

To fully enable the software and its functionality described herein, the present disclosure begins with a summary of how computers may be used, either alone or in a networked configuration. FIG. 1 illustrates a hardware configuration 100 wherein a system and method for Electronic Payment Processing and Risk Analysis is implemented by managing a payment platform system used by different merchants and customers 101 connected over a network 103. The network 103 is suitable for connecting the one or more computers 104, 105 and 106, or mobile devices 110, 111, 112 and 113 and may comprise one or more networks such as a local area network (LAN), a wide area network (WAN) such as the Internet, telephone networks, including telephone networks with dedicated communication links and/or wireless links, and wireless networks. In the illustrative example shown in FIG. 1, the network 103 is the Internet. Each of the one or computers 104, 105 and 106, or mobile devices 110, 111, 112 and 113 is connected to the network 103 via a suitable communication link, such as a dedicated communication line or a wireless communication link.

In an embodiment, the system may be implemented using software that is either local or operating from a remote server such as a web server or cloud server over the Internet. Further, with the rapid growth of Internet technology and portable wireless technology, other computing devices, such as, but not limited to, cell phones, handheld devices, different portable tablets, or portable computers, may be used in place of or in addition to the one or more computers.

Each of the one or more computers 104, 105 and 106, comprises a central processing unit (CPU), an input/output (I/O) unit, a display device communicatively coupled to the I/O unit, a storage device, and a memory. Each of the one or more computers 104, 105 and 106, or mobile devices 110, 111, 112 and 113 may further comprise one or more standard input devices such as a keyboard, a mouse, speech processing means, or a touchscreen.

The memory includes a Graphical User Interface (GUI) that is used to convey information to and receive information from a user of the one or more computers 104, 105 and 106, or mobile devices 110, 111, 112 and 113 via the display device and I/O unit as described herein. The GUI includes any user interface capable of being displayed on a display device including, but not limited to, a web page, a display panel in an executable program, or any other interface capable of being displayed on the one or more computers 104, 105 and 106, or mobile devices' 110, 111, 112 and 113 respective display devices.

As will be recognized by one of skill in the art, each of the cell phones 110, hand-held devices 111, different portable tablets 112, or computers 113 may be configured similarly to the one or more computers 104, 105 and 106, or mobile devices 110, 111, 112 and 113, taking into account the various design considerations of these respective devices.

The GUI may be transmitted to the one or more computers 104, 105 and 106, or mobile devices 110, 111, 112 and 113 or other devices via the network 103. In one embodiment in accordance with the present invention, the GUI is displayed using commercially available hypertext markup language (“HTML”) viewing software such as, but not limited to, MICROSOFT INTERNET EXPLORER, GOOGLE CHROME, APPLE SAFARI, OR MOZILLA FIREFOX, or any other commercially available HTML viewing software.

The GUI may reside on a remote server or within the local hardware of the device. The remote server 102 may comprise one or more separate servers or may be a web server. The remote server 102 may comprise a CPU, memory, and separate storage device and be communicatively coupled to the network 103. The remote server 102 may contain an information storage device that may be a relational database, such as MICROSOFT' s SQL or any other database.

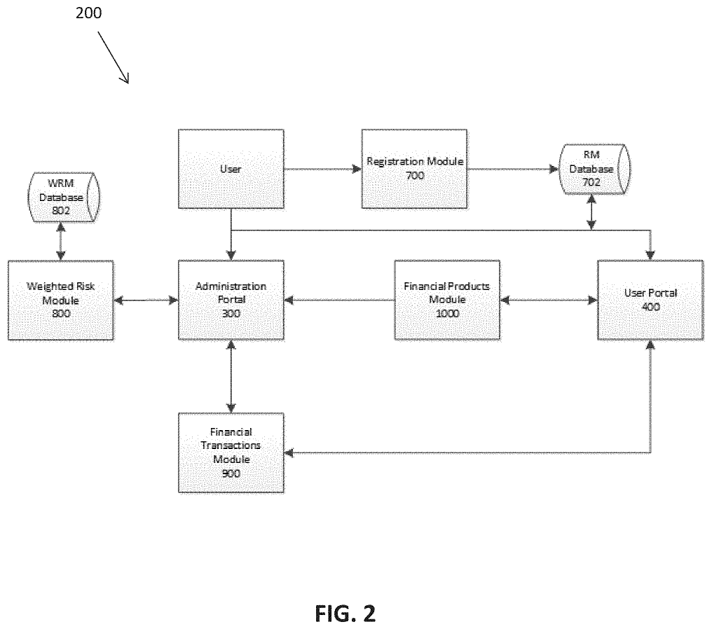

In a first embodiment the system 200, as illustrated in FIG. 2, the system 200 comprises a local computer or a backend cloud server configured with a GUI having an Administrator Portal (AP) 300 and a User Portal (UP) 400 communicatively coupled to a plurality of subroutines. The plurality of subroutines may include the AP300 configured to oversee users and control of the system 200, a Registration Module (RM) 700 configured to collet user registration data, a Weighted Risk Module (WRM) 800 configured to collect and analyze system 200 user risk data, a Financial Transactions Module (FTM) 900 configured facilitate financial transactions between users and customers, and a Financial Products Module (FPM) 1000 configured to administer financial products to users. Each respective module and subsequent collected data may be communicatively connected to share data through the system 200.

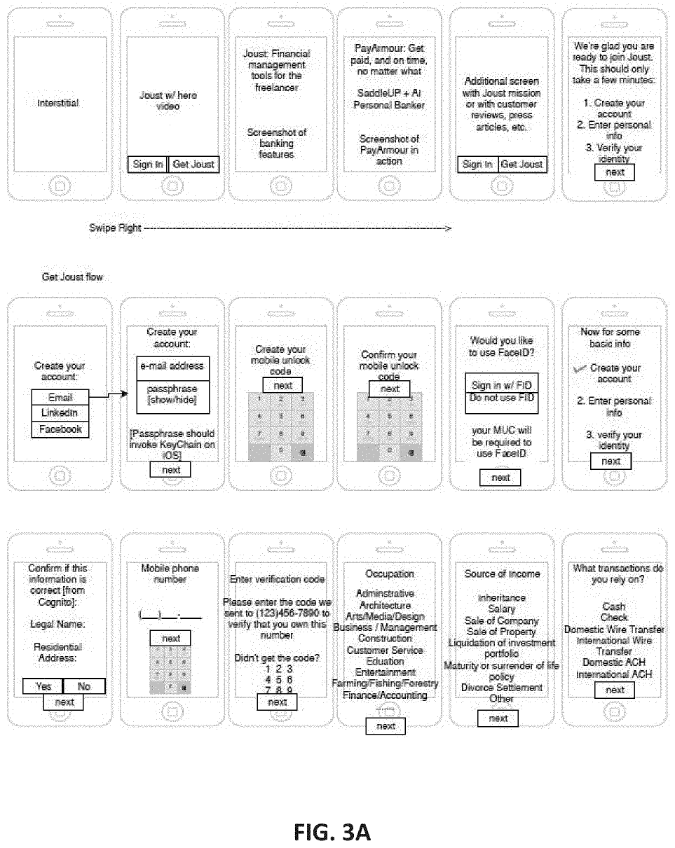

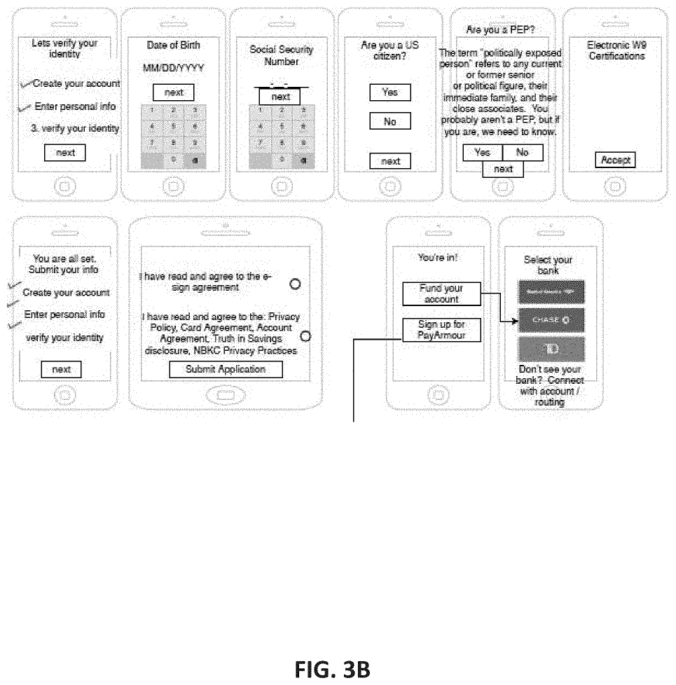

As shown in FIG. 2, if the user is entering the system for the first time, the user is prompted through the GUI to execute the RM 700. FIGS. 3A-B displays an example GUI rendering of the RM 700 as presented to a user. The RM 700 collects vital data including but not limited to identity information such as name, address, phone numbers, email, date of birth, social security number, financial institution data such as current bank accounts or credit cards and EIN number, and stores the registration data in the RM database 702. The RM database 702 is accessible via the AP 300, the UP 400, however, each portal is provisioned for different access to different data depending on the needs of the portal user. The AP 300 may have full access to all RM data, while the UP 400 user may have access to the user's own personal data and have the ability to search for and add clients and vendors.

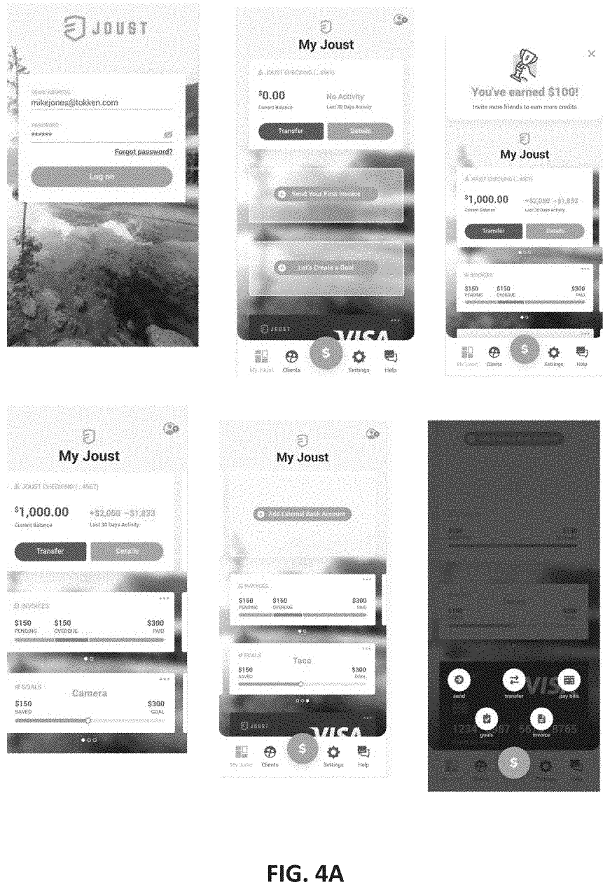

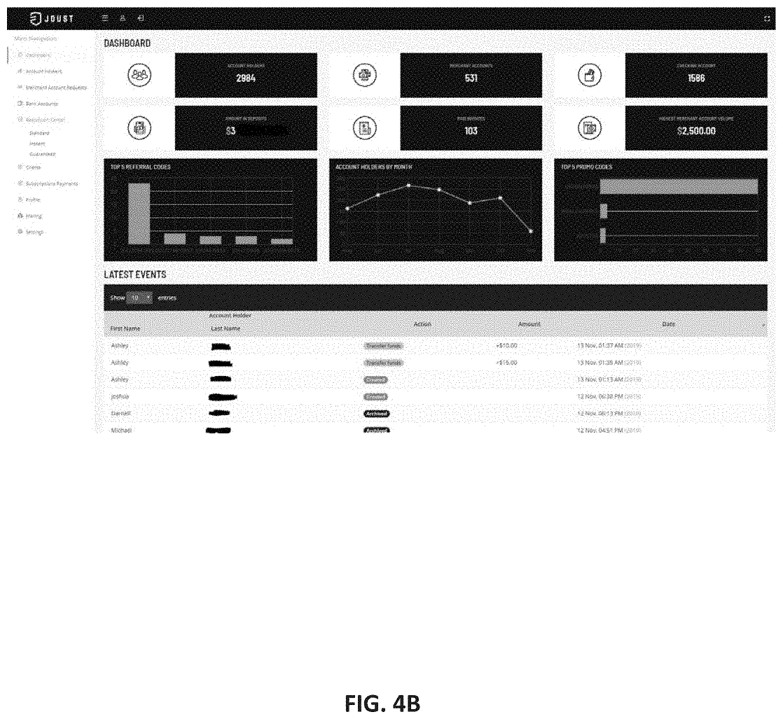

FIGS. 4A and 4B show an example GUI embodiment of the UP 400 client interface. When the user logs into the system 200 the user is directed to the UP 400 client interface. The UP 400 client interface allows the user through the GUI to search the RM database 702 for clients and vendors already active on the system 200, and to register with those selected as bill paying clients or vendors. If the user does not see the client or vendor needed, the user can add a client or vendor using the UP 400. Through the UP 400 interface the client or vendor may receive alerts and electronic messages when invoices are ready to be paid. Upon receiving an invoice or if the client chooses to pay at will, the client may initiate the FTM 900 to access payment account information stored in the RM database 702 and facilitate a payment to the user through the preferred and accepted payment methods. Upon making a payment, the user is notified through the FTM 900 and UP 400 that the transaction has been completed. Funds received by the user may be held on an account associated with the system 200 or transferred to other financial accounts of the user.

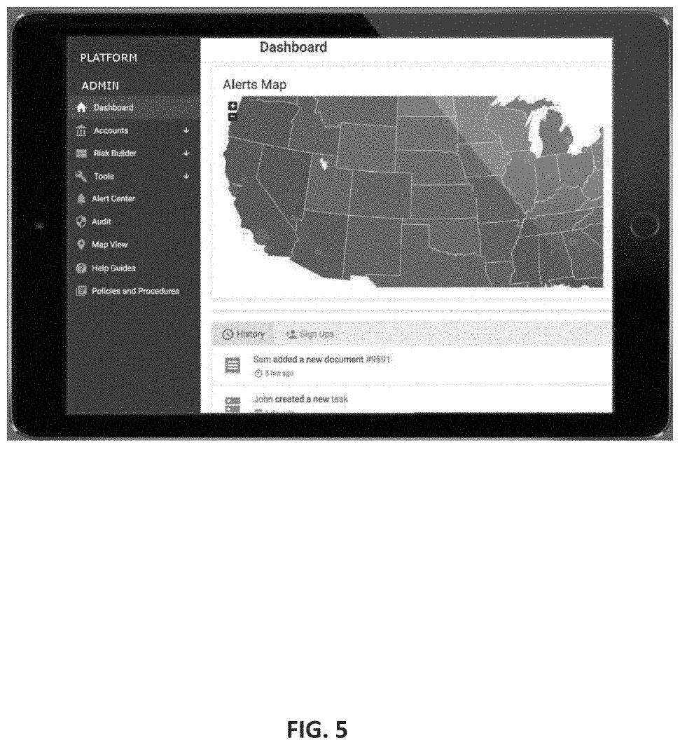

FIG. 5, shows an example GUI embodiment of the AP 300. The AP 300 is the exemplary GUI configured to access the AP 300. The AP 300 gives global oversite to all entities and transactions taking place within the system 200 and is configured to facilitate administrator control over the RM 700, WRM 800, FTM 900 and FPM 1000.

Through the AP 300, the administrative user may access the WRM 800 or “Risk Builder” module. The WRM 800 acts as data mining and analytics engine, which has pattern recognition and machine learning programs to analyze data in the WRM database 802.The WRM 800 is further configured to access the RM database 702, and pool together the necessary data required to connect to external databases to retrieve results pertinent to the risk factors identified. The WRM 800 further includes a WRM database 802 that stores data that correlates with data characteristic/risk factor of a user, client or vendor. The WRM database 802 includes connectivity with various other databases to enable verification and correlation with identity records, credit reports, banking records, phone records, residence records, and other records of the user, client or vendor.

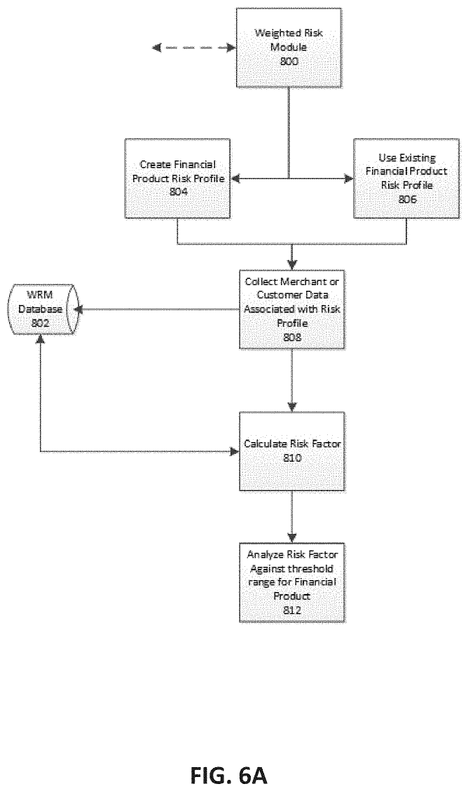

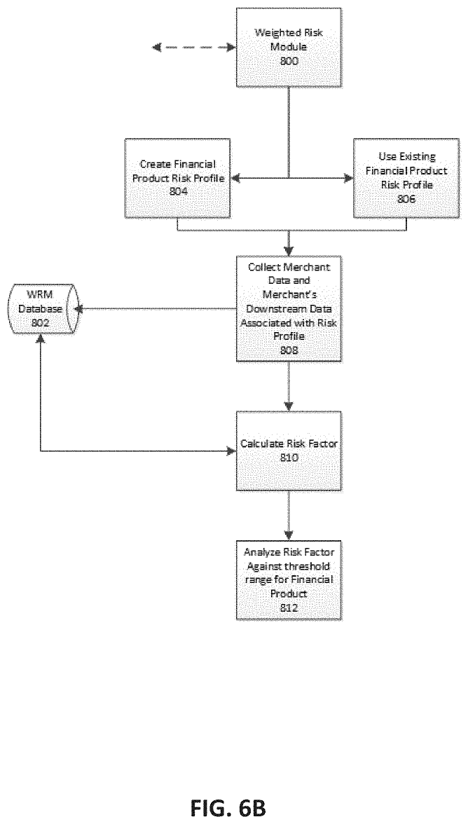

In operation, as outlined in FIG. 6A, The WRM 800 is configured to allow the administrative user to create a risk profile by presenting the user with a list of risk factors to help the user calculate the potential risk of a user or customer in connection with offering a particular financial product 804 or allow the user to select a pre-existing risk profile 806. The risk factors may include but are not limited to a particular credit score, existence of a criminal record, any government sanctions, social media presence, political presence and notoriety, and residence history. After the risk factors have been selected, the user may then apply additional importance weighting to each risk factor. For example, if the administrative user (AU) believes a history of criminal activity is most important in making a decision regarding the offering or a particular financial product, the AU may apply additional weighting points or percentages to that factor to further effect the calculation of the overall risk score. Once the factors and weighting have been determined, the AU may execute a risk assessment on a user or client to collect data 808, calculate the risk factor 810 based upon the data collected in association with the weighting factors, and analyze the risk factor against a threshold range determined by the user for each financial product 812. If the user or client is within the threshold range, the financial product may be offered with a certain set of beneficial terms, if the user or client is outside of the threshold range the financial product may be offered with less beneficial terms (i.e. a higher interest rate) or not offered at all.

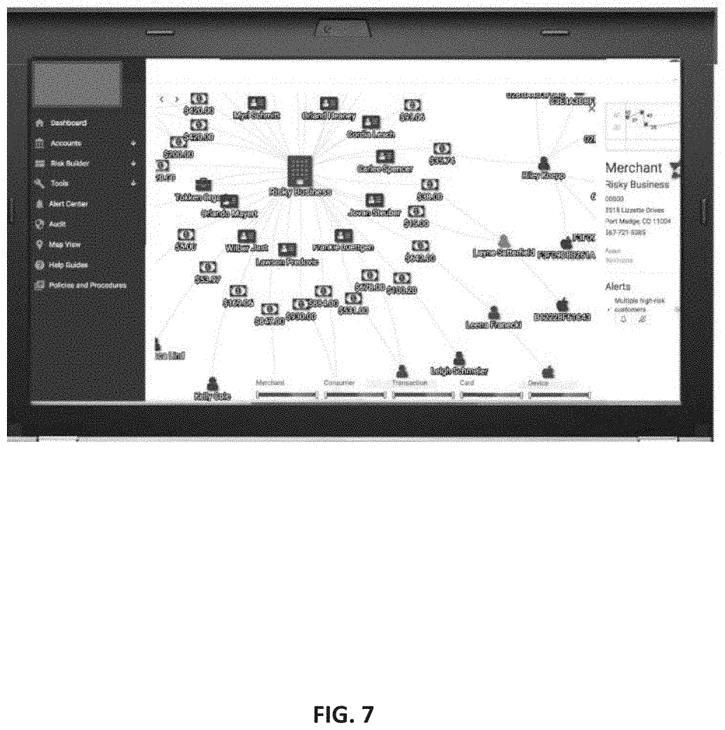

In an additional embodiment of the WRM 800 as shown in FIG. 6B, the WRM 800 takes additional risk factor analysis steps when analyzing users. In this embodiment, not only does the system collect the user's data as described above, but it also collects and analyzes the same data for every client of the user, or in some cases every downstream transaction (i.e. the clients of a client if both clients are registered on the system 200). In this embodiment the administrator can take a one-time snapshot of the user and all downstream transactions, or allow the WRM 800 to continually calculate and update risk scores real time or at set intervals. In this embodiment, the financial products administrator gains a fuller understanding and risk profile of users. By way of example, a user may not have a distinguished credit history and has moved around a lot, which in traditional risk analysis models may present the user as high risk, however, if a vast majority of the user's clients are well-established and reputable, have a longstanding presence and history of operations, etc. . . . then the administrator would be able to see that the user's clients are very reliable and likely to pay the user and the users risk factor could be lowered. By way of contrast, if a user has a traditionally very low risk score with high credibility, but all of the user's clients and downstream transactions present a high risk or potential for criminal activity, then the risk factor would likely be raised because the of the likelihood of user and client issues presented to operators of the financial platform. FIG. 7 shows a WRM 800 graphical analysis of a user in this embodiment. The user is designated as risky based on the downstream risky transactions of the user's clients.

In some embodiments of the AP 300 as shown in FIG. 5 a geographical risk profile is rendered. In these embodiments, the WRM database 802 tracks the geographical location of high-risk downstream transactions and creates a visual density map showing what regions are at highest risk. This allows an administrator to add additional risk factors in dealing with users or clients in certain geographical locations, and to allocate compliance resources effectively.

In yet another embodiment of the system, the weighted risk scores are used to determine the potential risk of offering a user invoice insurance or an invoice-based line of credit through the FPM 1000. These invoice protection products help independent contractors, freelancers, and micro businesses to mitigate the risk of non-payment. Through the FPM 1000 users can choose an invoice assurance tool that provides factoring on invoices for a fee, or is configured to allow the user to access an instant line of credit backed by the value of the invoice. The line of credit or invoice assurance fee may be determined by the risk factors calculated in the through the WRM 800. In this instance, if a user has a very low risk score with highly reliable customers, the administrators of the financial product may charge a lesser transaction fee or provide a higher line of credit because whereas a high risk score with unreliable customers may cause the administrators of the financial product to charge higher fees and extend a lower line of credit if any. The real-time calculations provided by the WRM 800 significantly speeds up the traditional underwriting process of providing financial products.

The systems and methods of the present invention may be embodied in various forms, including, for example, a data processor, such as the computer that also includes a database. Moreover, the above-noted features and other aspects and principles of the instant disclosure may be implemented in various environments. Such environments and related applications may be specially constructed for performing the various processes and operations of the instant disclosure, or they may include a general-purpose computer or computing platform selectively activated or reconfigured by code to provide the necessary functionality.

Whereas particular aspects of this invention have been described above for purposes of illustration, it will be evident to those skilled in the art that numerous variations of the details of the present invention may be made without departing from the invention.

Network and communication between the various modules may include, alone or in any suitable combination, a telephony-based network, a local area network (LAN), a wide area network (WAN), a dedicated intranet, the Internet or World Wide Web, a wireless network, a bus, or a backplane. Further, any suitable combination of wired and/or wireless components and systems may be incorporated into the network. Moreover, the network may be embodied as bi-directional links or as unidirectional links.

### EXAMPLE 1

In application of the previously disclosed system, a method of providing electronic financial services is provided comprising: receiving, by a server via a graphical user interface supported by the server, user identifying data and user financial account data and client identifying data and client financial account data; creating or modifying a user profile or client profile on the server and assigning weighted risk percentages and metes and bounds to a plurality of risk factor categories; and using the user identifying data and user financial account data by the server to generate a user weighted risk profile wherein the steps of creating the user weighted risk profile further include the steps of:the server relaying user identifying data and user financial account data client identifying data and client financial account data to a plurality of credit check databases and background check databases; the server retrieving user and client credit data and user and client background check data from the plurality of credit check databases and background check databases; and the server analyzing the user and client credit data and user and client background check data and the user or client credit data against the weighted risk percentages and metes and bounds of the plurality of risk factor categories of the user profile or client profile and further assign a user a risk value based on the user and associated clients of the user.

In some aspects of the method of the server comprises an externally networked cloud server having a front end graphical user interface comprising a plurality of communicatively coupled subroutines including a registration subroutine, an administration portal subroutine, a user portal subroutine, a financial transactions subroutine, a financial products subroutine and a weighted risk subroutine.

In additional aspects of the method that may include any of the previously disclosed steps, the step of receiving, by a server via a graphical user interface supported by the server, user identifying data and user financial account data and client identifying data and client financial account data, further includes the step of executing the registration subroutine and entering the user financial account data and client identifying data and client financial account data through the graphical user interface into a server database.

In additional aspects of the method that may include any of the previously disclosed steps, the step of creating or modifying a user profile or client profile on the server and assigning weighted percentages and metes and bounds to a plurality of risk factor categories further comprises the step of accessing the administration portal subroutine through the graphical user interface and entering or modifying risk factor categories of the plurality of risk factor categories and assigning and assigning the weighted risk percentages and metes and bounds based a commercial account type of the user.

In additional aspects of the method that may include any of the previously disclosed steps, the method may further include the step of the user and client initiating financial transactions or financial products through the financial transaction subroutine or through the financial products subroutine communicatively coupled to the graphical user interface.

In additional aspects of the method that may include any of the previously disclosed steps, the server compares the calculated user or client risk value with a predetermined threshold risk value and further offers the user or client financial products through the financial products subroutine through the graphical user interface to users or clients that have calculated user or client risk values that exceed the predetermined threshold risk value.

In additional aspects of the method that may include any of the previously disclosed steps, the step of offering a financial product of including system advanced payment of invoices prior to client payment of invoices if the calculated user or client risk value is higher than the predetermined threshold risk value.

In additional aspects of the method that may include any of the previously disclosed steps, the step of paying a percentage of the invoices in advanced based on the calculated user or client risk value.

In additional aspects of the method that may include any of the previously disclosed steps, the server receives geographic location data of the user or client and adjusts the user or client risk value based upon an amount of crime or fraud associated with financial transactions in the geographic location.

### EXAMPLE 2

In application of the previously disclosed system, a non-transitory computer-readable storage medium having computer-executable program instructions stored thereon is disclosed, the computer-executable program instructions when executed by a processor, cause the at least one computing device to: display, by a computing device, a graphical user interface including instructions for processing an electronic financial transaction including: entering user identifying data and user financial account data and client identifying data and client financial account data; transmitting the user identifying data and user financial account data and client identifying data and client financial account data to server via the graphical user interface; the server or a sever administrator creating or modifying a user profile or client profile on the server and assigning weighted risk percentages and metes and bounds to a plurality of risk factor categories; the server further using the user identifying data and user financial account data by the server to generate a user weighted risk profile wherein the steps of creating the user weighted risk profile further include the steps of: the server relaying user identifying data and user financial account data client identifying data and client financial account data to a plurality of credit check databases and background check databases; the server retrieving user and client credit data and user and client background check data from the plurality of credit databases and background check databases; the server analyzing the user and client credit data and user and client background check data and the user or client credit data against the weighted percentages and metes and bounds of the plurality of risk factor categories of the user profile or client profile and further assign a user a risk value based on the user and associated clients of the user; and the server determining available financial products for the user and client by comparing the calculated risk value with a predetermined financial product calculated risk value; and wherein the computing device receives from the server the available financial products for the user and client and displays the available financial products for the user and client to execute through the graphical user interface.

In additional aspects of the non-transitory computer-readable storage medium that may include any of the previously disclosed elements, the server comprises an externally networked cloud server having a front end graphical user interface comprising a plurality of communicatively coupled subroutines including a registration subroutine, an administration portal subroutine, a user portal subroutine, a financial transactions subroutine, a financial products subroutine and a weighted risk subroutine.

In additional aspects of the non-transitory computer-readable storage medium that may include any of the previously disclosed elements, the registration subroutine allows users and clients to enter the user financial account data and client identifying data and client financial account data through the graphical user interface into a server database.

In additional aspects of the non-transitory computer-readable storage medium that may include any of the previously disclosed elements, the administration portal subroutine is configured to create or modify a user profile or client profile on the server and assign weighted percentages and metes and bounds to a plurality of risk factor categories.

In additional aspects of the non-transitory computer-readable storage medium that may include any of the previously disclosed elements, the financial transaction subroutine is configured to execute and facilitate financial transactions between the user and the client or wherein the financial products subroutine is configured for a system administrator to offer a user financial products and further configured for the user to execute the financial products.

In additional aspects of the non-transitory computer-readable storage medium that may include any of the previously disclosed elements, a financial product of the system includes system advanced payment of invoices prior to client payment of invoices if the calculated user or client risk value is higher than a predetermined threshold risk value for the financial product.

In additional aspects of the non-transitory computer-readable storage medium that may include any of the previously disclosed elements, the financial product pays a percentage of the invoices in advanced based on the calculated user or client risk value.

In additional aspects of the non-transitory computer-readable storage medium that may include any of the previously disclosed elements, the server receives geographic location data of the user or client and adjusts the user or client risk value based upon an amount of crime or fraud associated with financial transactions in the geographic location.

### EXAMPLE 3

In application of the previously disclosed system, system for financial transaction comprises: a backend externally networked cloud server having a executable software capable of operating on the backend externally networked cloud server, the executable software including a front end graphical user interface risk evaluation portal and a plurality of subroutines defining a weighted risk, risk data, risk, and risk data collection; the risk evaluation portal configured to execute a plurality of software subroutines stored on the cloud server comprising a weighted risk subroutine, risk data collection subroutine, and a risk analysis subroutine; the weighted risk subroutine configured to direct an administrative user to create or modify a candidate profile and assign weighted percentages and metes and bounds to a plurality of risk factor categories; the risk data collection subroutine configured to input user identifying data or retrieve user identifying data stored on the cloud server and further relay the user identifying data to a plurality of credit databases and background check databases and retrieve user credit data and customer background check data from the plurality of credit databases and background; the risk data collection subroutine further configured to input secondary customer identifying data or retrieve secondary customer identifying data stored on the cloud server and further relay the secondary customer identifying data to the plurality of credit databases and background check databases, and retrieve secondary customer credit data and secondary customer background check data from the plurality of credit databases and background; and the risk analysis subroutine configured to analyze the user credit data and background check data and the secondary customer credit data and secondary customer background check data against the weighted percentages and metes and bounds of the plurality of risk factor categories of the candidate profile and further assign a user risk value based on the entirety of the user identifying data and secondary customer data.

In additional aspects of the system that may include any of the previously disclosed elements, the system further includes a financial transaction subroutine configured to execute and facilitate financial transactions between the user and a secondary customer.

In additional aspects of the system that may include any of the previously disclosed elements, a financial products subroutine is configured for a system administrator to offer a user or secondary customer financial products and further configured for the user to execute the financial products.

In additional aspects of the system that may include any of the previously disclosed elements, a financial product of the system includes advanced payment of invoices to user prior to secondary customer payment of invoices if the calculated user or client risk value is higher than a predetermined threshold risk value associated with the financial product.

In additional aspects of the system that may include any of the previously disclosed elements, the financial product pays a percentage of the invoices in advanced based on the calculated user or client risk value.

In additional aspects of the system that may include any of the previously disclosed elements, the server receives geographic location data of the user or secondary customer and adjusts the user or client risk value based upon an amount of crime or fraud associated with financial transactions in the geographic location.

The processes disclosed herein are not inherently related to any particular computer or other apparatus, and may be implemented by a suitable combination of hardware, software, and/or firmware. For example, various general-purpose machines may be used with programs written in accordance with the instant teachings, or it may be more convenient to construct a specialized apparatus or system to perform the required methods and techniques.

Apparatus, systems and methods consistent with the instant disclosure also include computer-readable media (or memory) that include program instructions or code for performing various processing device-implemented operations based on the methods and processes described herein. The media and program instructions may be those specially designed and constructed for the purposes of the instant disclosure, or they may be of the kind well known and available to those having skill in the computer software arts. Examples of program instructions include, for example, machine code, such as produced by a compiler, and files containing a high-level code that can be executed by the computer using an interpreter.

While particular preferred embodiments have been shown and described, it is to be understood that the foregoing description is exemplary and explanatory only and is not restrictive of the instant disclosure. Those skilled in the art will appreciate that changes and additions may be made without departing from the instant teachings. For example, the teachings of the instant disclosure may be directed to various combinations and sub-combinations of the disclosed features and/or combinations and sub-combinations of several further features described herein. It is therefore contemplated that any and all modifications, variations or equivalents of the above-described teachings fall within the scope of the basic underlying principles disclosed above and claimed herein.

1. A method of providing electronic financial services comprising:
receiving, by a server via a graphical user interface supported by the server, user identifying data and user financial account data and client identifying data and client financial account data;
creating or modifying a user profile or client profile on the server and assigning weighted risk percentages and metes and bounds to a plurality of risk factor categories; and
using the user identifying data and user financial account data by the server to generate a user weighted risk profile wherein the steps of creating the user weighted risk profile further include the steps of:
the server relaying user identifying data and user financial account data client identifying data and client financial account data to a plurality of credit check databases and background check databases;
the server retrieving user and client credit data and user and client background check data from the plurality of credit check databases and background check databases; and
the server analyzing the user and client credit data and user and client background check data and the user or client credit data against the weighted risk percentages and metes and bounds of the plurality of risk factor categories of the user profile or client profile and further assign a user a risk value based on the user and associated clients of the user.

2. The method of providing electronic financial services of claim 1 wherein the server comprises an externally networked cloud server having a front end graphical user interface comprising a plurality of communicatively coupled subroutines including a registration subroutine, an administration portal subroutine, a user portal subroutine, a financial transactions subroutine, a financial products subroutine and a weighted risk subroutine.

3. The method of providing electronic financial services of claim 2 wherein the step of receiving, by a server via a graphical user interface supported by the server, user identifying data and user financial account data and client identifying data and client financial account data, further includes the step of executing the registration subroutine and entering the user financial account data and client identifying data and client financial account data through the graphical user interface into a server database.

4. The method of providing electronic financial services of claim 2 wherein the step of creating or modifying a user profile or client profile on the server and assigning weighted percentages and metes and bounds to a plurality of risk factor categories further comprises the step of accessing the administration portal subroutine through the graphical user interface and entering or modifying risk factor categories of the plurality of risk factor categories and assigning and assigning the weighted risk percentages and metes and bounds based a commercial account type of the user.

5. The method of providing electronic financial services of claim 2 further including the step of the user and client initiating financial transactions or financial products through the financial transaction subroutine or through the financial products subroutine communicatively coupled to the graphical user interface.

6. The method of providing electronic financial services of claim 5 wherein the server compares the calculated user or client risk value with a predetermined threshold risk value and further offers the user or client financial products through the financial products subroutine through the graphical user interface to users or clients that have calculated user or client risk values that exceed the predetermined threshold risk value.

7. The method of providing electronic financial services of claim 6 further including the step of offering a financial product of including system advanced payment of invoices prior to client payment of invoices if the calculated user or client risk value is higher than the predetermined threshold risk value.

8. The method of providing electronic financial services of claim 7 further including the step of paying a percentage of the invoices in advanced based on the calculated user or client risk value.

9. The method of providing electronic financial services of claim 7 wherein the server receives geographic location data of the user or client and adjusts the user or client risk value based upon an amount of crime or fraud associated with financial transactions in the geographic location.

10. A non-transitory computer-readable storage medium having computer-executable program instructions stored thereon that when executed by a processor, cause the at least one computing device to:
display, by a computing device, a graphical user interface including instructions for processing an electronic financial transaction including:
entering user identifying data and user financial account data and client identifying data and client financial account data;
transmitting the user identifying data and user financial account data and client identifying data and client financial account data to server via the graphical user interface;
the server or a sever administrator creating or modifying a user profile or client profile on the server and assigning weighted risk percentages and metes and bounds to a plurality of risk factor categories;
the server further using the user identifying data and user financial account data by the server to generate a user weighted risk profile wherein the steps of creating the user weighted risk profile further include the steps of:
the server relaying user identifying data and user financial account data client identifying data and client financial account data to a plurality of credit check databases and background check databases;
the server retrieving user and client credit data and user and client background check data from the plurality of credit databases and background check databases;
the server analyzing the user and client credit data and user and client background check data and the user or client credit data against the weighted percentages and metes and bounds of the plurality of risk factor categories of the user profile or client profile and further assign a user a risk value based on the user and associated clients of the user; and
the server determining available financial products for the user and client by comparing the calculated risk value with a predetermined financial product calculated risk value; and
wherein the computing device receives from the server the available financial products for the user and client and displays the available financial products for the user and client to execute through the graphical user interface.

11. The non-transitory computer-readable storage medium of claim 10 wherein the server comprises an externally networked cloud server having a front end graphical user interface comprising a plurality of communicatively coupled subroutines including a registration subroutine, an administration portal subroutine, a user portal subroutine, a financial transactions subroutine, a financial products subroutine and a weighted risk subroutine.

12. The non-transitory computer-readable storage medium of claim 11 the registration subroutine allows users and clients to enter the user financial account data and client identifying data and client financial account data through the graphical user interface into a server database.

13. The non-transitory computer-readable storage medium of claim 11 wherein the administration portal subroutine is configured to create or modify a user profile or client profile on the server and assign weighted percentages and metes and bounds to a plurality of risk factor categories.

14. The non-transitory computer-readable storage medium of claim 11 wherein the financial transaction subroutine configured to execute and facilitate financial transactions between the user and the client or wherein the financial products subroutine is configured for a system administrator to offer a user financial products and further configured for the user to execute the financial products.

15. The non-transitory computer-readable storage medium of claim 14 wherein a financial product of the system includes system advanced payment of invoices prior to client payment of invoices if the calculated user or client risk value is higher than a predetermined threshold risk value for the financial product.

16. The non-transitory computer-readable storage medium of claim 15 wherein the financial product pays a percentage of the invoices in advanced based on the calculated user or client risk value.

17. The non-transitory computer-readable storage medium of claim 14 wherein the server receives geographic location data of the user or client and adjusts the user or client risk value based upon an amount of crime or fraud associated with financial transactions in the geographic location.

18. A system for financial transaction risk valuation comprising:
a backend externally networked cloud server having executable software capable of operating on the backend externally networked cloud server, the executable software including a front end graphical user interface risk evaluation portal and a plurality of subroutines defining a weighted risk, risk data, risk, and risk data collection;
the risk evaluation portal configured to execute a plurality of software subroutines stored on the cloud server comprising a weighted risk subroutine, risk data collection subroutine, and a risk analysis subroutine;
the weighted risk subroutine configured to direct an administrative user to create or modify a candidate profile and assign weighted percentages and metes and bounds to a plurality of risk factor categories;
the risk data collection subroutine configured to input user identifying data or retrieve user identifying data stored on the cloud server and further relay the user identifying data to a plurality of credit databases and background check databases and retrieve user credit data and customer background check data from the plurality of credit databases and background;
the risk data collection subroutine further configured to input secondary customer identifying data or retrieve secondary customer identifying data stored on the cloud server and further relay the secondary customer identifying data to the plurality of credit databases and background check databases, and retrieve secondary customer credit data and secondary customer background check data from the plurality of credit databases and background; and
the risk analysis subroutine configured to analyze the user credit data and background check data and the secondary customer credit data and secondary customer background check data against the weighted percentages and metes and bounds of the plurality of risk factor categories of the candidate profile and further assign a user risk value based on the entirety of the user identifying data and secondary customer data.

19. The system for financial transaction risk valuation of claim 17 further including a financial transaction subroutine configured to execute and facilitate financial transactions between the user and a secondary customer.

20. The system for financial transaction risk valuation of claim 18 wherein a financial products subroutine is configured for a system administrator to offer a user or secondary customer financial products and further configured for the user to execute the financial products.

21. The system for financial transaction risk valuation of claim 19 wherein a financial product of the system includes advanced payment of invoices to user prior to secondary customer payment of invoices if the calculated user or client risk value is higher than a predetermined threshold risk value associated with the financial product.

22. The system for financial transaction risk valuation of claim 20 wherein the financial product pays a percentage of the invoices in advanced based on the calculated user or client risk value.

23. The system for financial transaction risk valuation of claim 19 wherein the server receives geographic location data of the user or secondary customer and adjusts the user or client risk value based upon an amount of crime or fraud associated with financial transactions in the geographic location.
